(19) United States
(12) Patent Application Publication
(10) Pub. No.: US 2001/0030516 A1
(43) Pub. Date: Oct. 18, 2001

(54) Motor synchronization apparatus

(76) Inventors: Fred A. Brown, Coronado, CA (US); Francisco Jauregui, Chula Vista, CA (US)

Correspondence Address: Steven G. Saunders, BROMBERG & SUNSTEIN LLP, 125 Summer Street, Boston, MA, 02110-1618, US

(21) Appl. No.: 09/731,884

(22) Filed: Dec. 7, 2000

Related U.S. Application Data
(60) Provisional application No. 60/169,568, filed on Dec. 8, 1999.

(51) Int. Cl. H02P 1/18; H02P 3/08; H02P 5/06; H02P 7/06; H02K 23/00

(52) U.S. Cl. 318/254

(57) ABSTRACT

An apparatus for controlling the speed of a motor (having a coil) rotating a load synchronizes the rotational speed of the load with a reference signal. To that end, the apparatus includes a commutation circuit for energizing the coil, a tachometer for detecting the speed that the load is rotating, and a synchronization module that synchronizes the rotation of the load to the reference signal. The tachometer produces a speed signal representing the speed that the load is rotating. The synchronization module includes a reference input that receives the reference signal, a tachometer input that receives the speed signal, a speed control module that compares the reference signal with the speed signal to produce a control signal that controls the commutation circuit, and a commutation circuit output for forwarding the control signal to the commutation circuit, the commutation circuit energizing the coil as specified by the control signal.

### PRIORITY

This application claims priority from U.S. provisional patent application Ser. No. 60/169,568, filed Dec. 8, 1999, entitled “Motor Synchronization Apparatus,” the disclosure of which is incorporated herein by reference.

### FIELD OF THE INVENTION

This invention generally relates to motors and, more particularly, the invention relates to synchronizing motor operation to a reference frequency.

### BACKGROUND OF THE INVENTION

Many systems utilize multiple D.C. motors in parallel for various reasons. For example, multiple fans are utilized to cool elevators, and many computer systems utilize two or more fans to cool internal electronic components. Such systems often are preconfigured so that the fans are synchronized to operate at a substantially identical rotational speed. In practice, however, although ideally set to operate synchronously, such fans typically operate at different speeds. When fans are not synchronized, they often generate a noise that many people tend to consider annoying.

### SUMMARY OF THE INVENTION

In accordance with one aspect of the invention, an apparatus and method for controlling the speed of a motor (having a coil) rotating a load synchronizes the rotational speed of the load with a reference signal. To that end, the apparatus includes a commutation circuit for energizing the coil, a tachometer for detecting the speed that the load is rotating, and a synchronization module that synchronizes the rotation of the load to the reference signal. The tachometer produces a speed signal representing the speed that the load is rotating. The synchronization module includes a reference input that receives the reference signal, a tachometer input that receives the speed signal, a speed control module that compares the reference signal with the speed signal to produce a control signal that controls the commutation circuit, and a commutation circuit output for forwarding the control signal to the commutation circuit, the commutation circuit energizing the coil as specified by the control signal.

In preferred embodiments, the control signal controls the commutation circuit to modify the speed that the load is rotating. The load may be an impeller, and the commutation circuit may comprise a hall sensor. The speed control module may be a hardware device, such as a processor that executes in accord with preprogrammed instructions.

In accordance with another aspect of the invention, a motor apparatus comprises a first motor for rotating a first load and having a first synchronization module, a second motor for rotating a second load and having a second synchronization module, and a master clock that produces a reference signal and is coupled with the first and second motors. The first synchronization module rotates the first load in accordance with the reference signal, and the second synchronization module rotates the second load in accordance with the reference signal.

In accordance with other aspects of the invention, a synchronization module for synchronizing rotation of a motor (having an energization circuit for controlling rotation of the motor) with a reference frequency includes a speed input that receives a speed signal representing the speed of rotation of the motor, a reference input that receives a reference signal having the reference frequency, and a speed control module operatively coupled with the two inputs. The speed control module compares the reference signal with the speed signal to produce a control signal having speed information that causes the motor to rotate at a preselected rate. The synchronization module also includes an output for forwarding the control signal to the energization circuit.

In another embodiment of the invention, a computer program product for use on a computer system for synchronizing motor rotation with a reference frequency, the motor having an energization circuit for controlling rotation of the motor. The computer program product comprises a computer usable medium having a computer program thereon. The computer readable program code includes computer code for receiving a speed input signal representing the speed of the rotation of the motor, receiving a reference signal having the reference frequency, and comparing the reference signal with the speed signal to produce a control signal. The control signal has speed information that causes the motor to rotate at a preselected rate. The computer code then outputs the control signal to the energization circuit. In various embodiments, the computer code may initially energize the motor at maximum speed by outputting the appropriate control signal.

### BRIEF DESCRIPTION OF THE DRAWINGS

The foregoing and other objects and advantages of the invention will be appreciated more fully from the following further description thereof with reference to the accompanying drawings wherein:

FIG. 1 schematically shows a motor apparatus having multiple motors synchronized in accordance with preferred embodiments of the invention.

FIG. 2 schematically shows an exemplary DC brushless fan that may be configured with the synchronization circuit in accordance with preferred embodiments of the invention.

FIG. 3 schematically shows an impeller of the fan shown in FIG. 2.

FIG. 4 schematically shows a circuit diagram of the coil energization and synchronization circuits of preferred embodiments.

FIG. 5 shows a preferred process of synchronizing the rotational speed of a motor with a reference frequency.

FIG. 6 schematically shows an alternative circuit diagram of the coil energization and synchronization circuits utilizing H bridge circuitry.

### DESCRIPTION OF ILLUSTRATIVE EMBODIMENTS

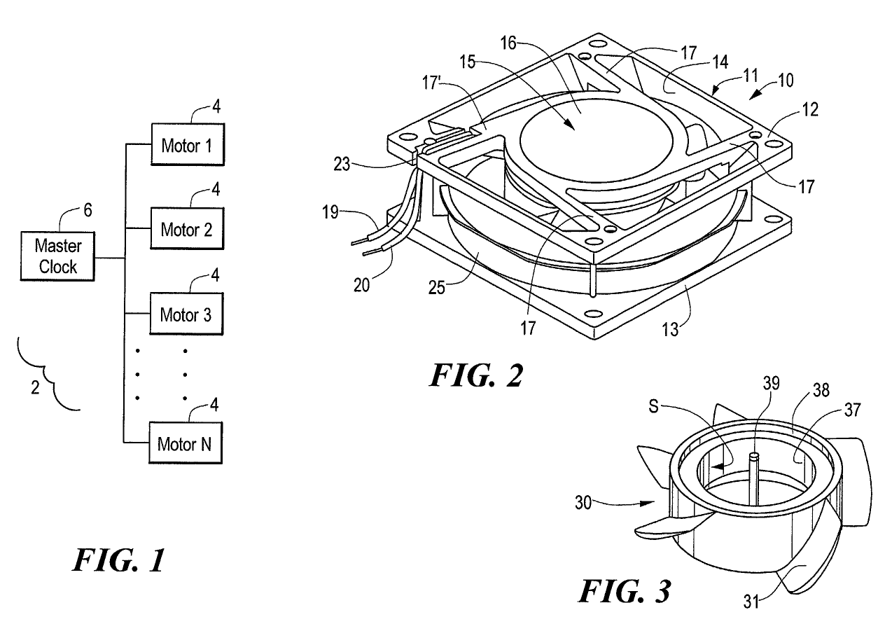

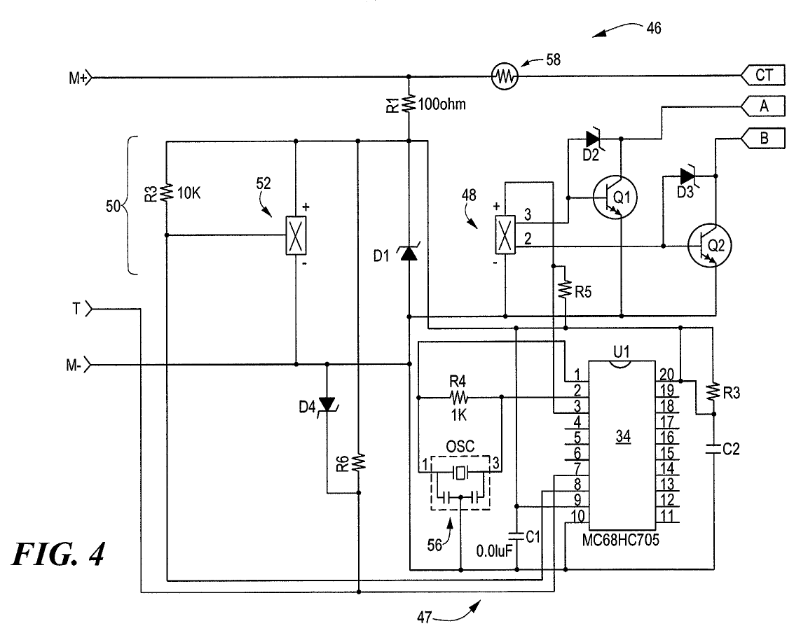

FIG. 1 schematically shows a motor apparatus 2 having multiple motors synchronized in accordance with preferred embodiments of the invention. More particularly. the motor apparatus 2 includes N motors (i.e., identified as motor 1, motor 2, motor 3 . . . motor N, and generally identified as motors 4) that each are synchronized to rotate at a rotational speed as specified by a master clock 6. Accordingly, each motor 4 has a motor synchronization circuit (discussed in detail below with reference to FIG. 4) that receives a reference signal from the master clock 6, and rotates its respective rotor at a rotational speed that is related to the reference frequency of the reference signal. The motor apparatus 2 may be any device known in the art that utilizes multiple motors 4. For example, the motor apparatus 4 may include parallel and/or serial motors.

In illustrative embodiments, the motors 4 each are fans that cool a computer system. Accordingly, various embodiments are discussed with reference to a fan. It should be noted, however, that discussion of a fan is by example only and not intended to limit the scope of the invention. FIG. 2 schematically shows an exemplary DC brushless fan that may be configured with the synchronization circuit discussed herein. As known in the art, the fan includes a housing 11 with a front surface 12, a rear surface 13, and venturi 14 extending between the front and rear surfaces 12 and i3.

The motor 4, located generally at 15, is centrally located in the housing 11. The motor 4 may be any conventional motor used within fans such as, for example, a single-phase or poly-phase motor. The winding circuit, synchronization circuit (discussed below), and stator are supported in fixed relation to the housing 11 in a central housing portion 16 that is connected to the venturi 14 by struts 17 of a spider structure. Leads 19 and 20 are brought out from the motor electronics along one strut 17′. Strut 17′ is specially formed for this purpose with a longitudinal channel leading to a narrow groove 23 at the outer periphery of the housing 11. The groove 23 retains the leads 19 and 20 in the channel while directing them toward the generally cylindrical exterior 25 of the housing 11 as shown.

FIG. 3 illustrates an impeller 30 of the fan 10 as shown in FIG. 2. The impeller 30 includes fan blades 31 supported on a hub 32 (e.g., manufactured from plastic), which in turn is secured to a rotor 35 of the fan motor 4. The rotor 35 has an annular permanent magnet 37 in a steel cup 38. The central shaft 39, which is secured to the end face of the cup 38, is received in bearings 41 in the stator assembly of FIG. 2b when the fan 10 is assembled. Of course, the impeller 30 also may be a propellor or other similar apparatus utilized in fans.

FIG. 4 schematically shows a commutation circuit 46 that is configured in accord with preferred embodiments to rotate the rotor 35 at a reference frequency prescribed by the master clock 6. To that end, the commutation circuit 46 includes a plurality of circuit elements that are coupled with a first coil (“coil A”), a second coil (“coil B”), and a center tap of the coils (identified by “CT”). As known in the art, the coils interact with the magnet 37 of the rotor 35 to effectuate rotor rotation. Accordingly, the circuit further includes a first hall sensor 48 having a first output to a first switching transistor Q1, and a second output to a second transistor Q2. Each transistor Q1 and Q2 has a respective Zener diode D2 and D3 for limiting its respective collector to base voltage.

In FIG. 4, the circuit 46 also includes a tachometer 50 for monitoring the rotation of the rotor 35. Accordingly, the tachometer 50 includes a second hall sensor 52 that is positioned in a manner that enables it to sense the magnetic field produced by the magnet 37 of the impeller 30. In addition, the tachometer 50 also includes a resistor R2. The commutation circuit 46 also includes another Zener diode D1 with a series resistor R1 for voltage regulation, a Zener D4 with resistor R6 to maintain constant input voltage, and a motor protection device 58, such as a positive temperature coefficient thermistor (commonly referred to as a “PTC”). Use of the motor protection device 58 helps to ensure that the fan motor windings are protected from high current conditions.

In accord with preferred embodiments of the invention, the commutation circuit 46 also includes a synchronization circuit 47 for synchronizing the rotation of the rotor 35 with the reference signal received from the master clock 6. To that end, the synchronization circuit 47 includes a processor 54 that is programmed to maintain the rotor speed in sync with the reference signal. The processor 54 may be any processor known in the art, such as a model number MC68HC705 processor, available from Motorola, Inc. of Schaumberg, Ill. The processor 54 operates at a rate specified by some clock, such as an external oscillator 56.

The exemplary processor 54 has twenty pins numbered from 1 to 20. The pins are coupled to the following elements:

pins 1 and 2: to the oscillator 56 to receiving a timing signal;

pin 3: this pin is an output to the commutation circuit 46 to control the energization of the coils A and B and consequently, the rotational speed of the motor 4;

pins 4-6a, 11-19: unused;

pin 7 is a reference signal input that is coupled with the master clock 6 to receive the reference signal;

pin 8 is a tachometer input that receives a speed signal (identifying the speed of the rotor 35) from the tachometer 50;

pins 9 and 10 receive power from a power supply; and

pin 20 is coupled with a capacitor C2 and resistor R3 that are utilized for startup delay and reset purposes.

A prototype built that should produce satisfactory results has the following element values:

R1: 100 ohms;

R2: 10,000 ohms;

R3: 2.4 megaohms;

R4: 1 megaohm;

R5: 260 ohms;

C1: 0.01 microfarads; and

C2: 2.2 microfarads

D1 and D4: 5.1 volt Zener diodes; and

D2 and D3: 32 volt Zener diodes for a 12 volt applications.

It should be noted that all element values recited herein are exemplary and may be adjusted by those skilled in the art. Accordingly, these values are not intended to limit preferred embodiments of the invention.

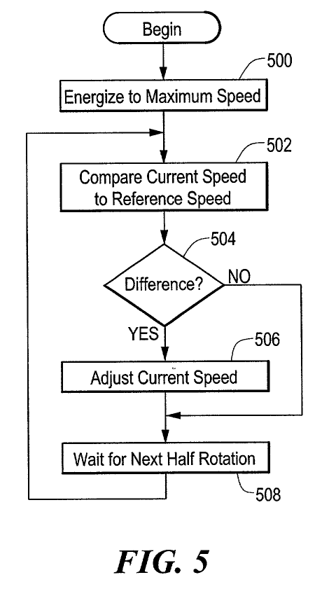

As noted above, the processor 54 is preprogrammed to execute in accordance with a set of instructions. FIG. 5 shows one such process executed by the processor 54 for maintaining the rotor speed at a preselected rate. The process becins at step 500 in which the coils A and B are energized to rotate the rotor 35 at its maximum speed. Forcing the rotor 35 to its maximum speed reduces the effect of inertia of startup. The process then continues to step 502 in which the current speed, as determined by the tachometer 50, is compared with the reference frequency in the reference signal. For example, the reference signal may have a frequency of 120 hertz. Accordingly, the frequency of the speed signal from the tachometer 50 (i.e., at this point in time, the maximum frequency), is compared against 120 hertz.

If it is determined at step 504 that there is a difference between the reference signal and the speed signal, then the process continues to step 506, in which the current speed of the rotor 35 is adjusted appropriately. For example, the speed may be reduced a preselected amount from the maximum speed. If, at step 504, there was no difference between the reference signal and the speed signal, then the process skips to step 508, in which the processor 54 waits for the next half rotation of the rotor 35, and then loops back to step 502 to compare the two signals. Accordingly, the speed of the rotor 35 preferably is checked and, if necessary, adjusted about every half revolution of the rotor 35. This process continues until the motor 4 no longer is operating. Of course, the reference signal is the same as that received by each of the parallel motors 4 (i.e., fans) in the motor apparatus 2 shown in FIG. 1, consequently causing each motor 4 to operate at approximately the same operating speed.

As noted above, the processor 54 is preprogrammed to execute the process shown in FIG. 5 to effectuate synchronous rotation of each motor 4. In preferred embodiments, assembly language specific to the processor 54 is utilized.

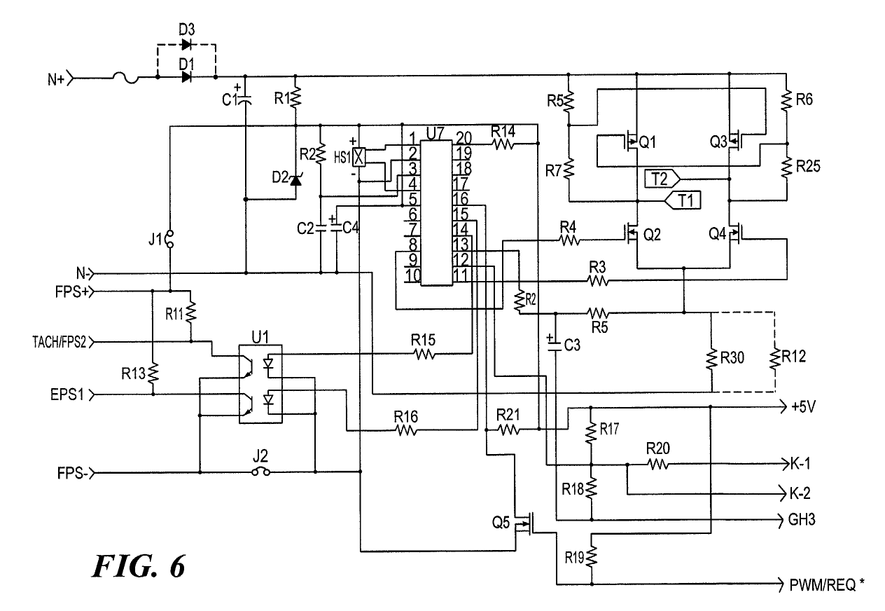

In alternative embodiments, the commutation circuit may include, but is not limited to, an H-bridge configuration, using transistors Q1-Q4 as shown in FIG. 6. Utilizing H-bridge drive configurations allows 100% of the coil in the motor to be utilized in either direction, without requiring a centertap. In FIG. 6, Q2 and Q4 can be switched on or off by the microprocessor U2 via pins 10 and 11, respectively. When transistors Q1 and Q4 are on, current flows through coil inputs T1 and T2 in one direction. When transistors Q2 and Q3 are on, the current direction is reversed. Note that microprocessor U2 can direct multiple tasks. in addition to controlling the speed of the motor(s). For example, U1 and outputs FPS1 and FPS2 are unrelated to speed control functionality.

It is expected that preferred embodiments can control a wide range of rotational speeds. For example, preferred embodiments should control commonly used speed ratios ranging from 600 to 6,000 revolutions per minute, while synchronizing fan speeds (of multiple fans) to within 1.5 revolutions per second. Of course, many embodiments should control speeds outside of this range. Moreover, preferred embodiments should be scalable to many sizes of fans. Since there is a minimum of components, the synchronization circuit 47 can be integrated with existing motor commutation circuits.

In an alternative embodiment, the disclosed apparatus and method for synchronizing motor operation to a reference frequency may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adaptor connected to a network over a medium. The medium may be either a tangible (e.g., optical or analog communications lines) or a medium implemented with wireless techniques (e.g., microwave, infrared, or other transmission techniques). The series of computer instructions embodies all or part of the functionality previously described herein with respect to the system and method. Those skilled in the art should appreciate that such computer instructions can be written in a number of programming languages for use with may computer architectures or operating systems. Further, such instructions may be stored in any memory device, such as a semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), pre-loaded with a computer system (e.g., on system ROM or fixed disk), or distributed from a server or electronic bulletin board over a network (e.g. the Internet or World Wide Web). Of course, some embodiments of the invention may be implemented as a combination of both software (e.g., a computer program product) and hardware. Still other embodiments of the invention are implemented as entirely hardware, or entirely software (e.g, a computer program product).

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

We claim:

1. An apparatus for controlling the speed of a motor rotating a load, the motor having a coil that controls the rotation of the load, the apparatus comprising:
a commutation circuit for energizing the coil;
a tachometer for detecting the speed that the load is rotating, the tachometer producing a speed signal representing the speed that the load is rotating; and
a synchronization module that synchronizes the rotation of the load to a reference signal, the synchronization module comprising:
a reference input that receives the reference signal;
a tachometer input coupled with the tachometer to receive the speed signal;
a speed control module that compares the reference signal with the speed signal to produce a control signal that controls the commutation circuit; and
a commutation circuit output for forwarding the control signal to the commutation circuit, the commutation circuit energizing the coil as specified by the control signal.

2. The apparatus as defined by claim 1 wherein the control signal controls the commutation circuit to modify the speed that the load is rotating.

3. The apparatus as defined by claim 1 wherein the load is a impeller.

4. The apparatus as defined by claim 1 wherein the commutation circuit comprises a hall sensor.

5. The apparatus as defined by claim 1 wherein the speed control module is a processor.

6. The apparatus as defined by claim 5 wherein the processor executes in accord with preprogrammed instructions.

7. A motor apparatus comprising:
a first motor for rotating a first load and having a first synchronization module; and
a second motor for rotating a second load and having a second synchronization module; and
a master clock that produces a reference signal, the master clock being coupled with both the first motor and the second motor,
the first synchronization module rotating the first load in accordance with the reference signal,
the second synchronization module rotating the second load in accordance with the reference signal.

8. The motor apparatus as defined by claim 7 wherein the first load is a first impeller, and the second load is a second impeller.

9. The motor apparatus as defined by claim 7 wherein the first synchronization module includes a first reference input, and the second synchronization module includes a second reference input, the first and second reference inputs being coupled with the master clock to receive the reference signal.

10. The motor apparatus as defined by claim 7 wherein the first load and second load rotate at substantially the same rate.

11. The motor apparatus as defined by claim 7 wherein the first synchronization module comprises a processor.

12. A synchronization module for synchronizing motor rotation with a reference frequency, the motor having an energization circuit for controlling rotation of the motor, the synchronization module comprising:
a speed input that receives a speed signal representing the speed of the rotation of the motor;
a reference input that receives a reference signal having the reference frequency;
a speed control module operatively coupled with the reference input and the speed input, the speed control module comparing the reference signal with the speed signal to produce a control signal, the control signal having speed information that causes the motor to rotate at a preselected rate; and
an output for forwarding the control signal to the energization circuit.

13. The synchronization module as defined by claim 12 wherein speed control module is a processor.

14. A method for controlling the speed of a motor rotating a load, the motor having a coil that controls the rotation of the load, the method comprising:
energizing the coil using a commutation circuit;
detecting the speed that the load is rotating using a tachometer that produces a speed signal representing the speed that the load is rotating;
synchronizing the rotation of the load to a reference signal, the synchronizing comprising:
receiving the reference signal;
receiving the speed signal;
comparing the reference signal with the speed signal to produce a control signal that controls the commutation circuit; and
forwarding the control signal to the commutation circuit via a commutation circuit output.

15. A computer program product for use on a computer system for synchronizing motor rotation with a reference frequency, the motor having an enerization circuit for controlling rotation of the motor, the computer program product comprising a computer usable medium having a computer program thereon, the computer readable program code including:
computer code for receiving a speed input signal representing the speed of the rotation of the motor;
computer code for receiving a reference signal having the reference frequency;
computer code for comparing the reference signal with the speed signal to produce a control signal; the control signal having speed information that causes the motor to rotate at a preselected rate; and
computer code for outputting the control signal to the energization circuit.

16. A computer program product according to claim 14, further comprising:
computer code for outputting the control signal to the energization circuit so as to initially energize the motor at maximum speed.
